(19) United States
(12) Patent Application Publication
(10) Pub. No.: US 2010/0030623 A1
(43) Pub. Date: Feb. 4, 2010

(54) METHOD OF PROVIDING AN ONLINE MARKETPLACE

(76) Inventor: Inderpal Guglani, Gibsonia, PA (US)

Correspondence Address: BUCHANAN INGERSOLL & ROONEY PC, P.O. BOX 1404, ALEXANDRIA, VA, 22313-1404, US

(21) Appl. No.: 12/510,631

(22) Filed: Jul. 28, 2009

Related U.S. Application Data
(63) Continuation of application No. 12/509,916, filed on Jul. 27, 2009.
(60) Provisional application No. 61/084,375, filed on Jul. 29, 2008.
(60) Provisional application No. 61/193,025, filed on Oct. 22, 2008.
(60) Provisional application No. 61/193,990, filed on Jan. 15, 2009.
(60) Provisional application No. 61/202,684, filed on Mar. 26, 2009.

(51) Int. Cl. G06Q 30/00; G06Q 10/00; G06F 15/16

(52) U.S. Cl. 705/10; 705/26; 709/206

(57) ABSTRACT

A device configured to host a marketplace on at least one network is provided. A method of providing such a device is also disclosed. The apparatus includes at least one computer device configured to communicate with a plurality of clients via at least one network. The clients may include vendors, such as sellers, and customers, such as buyers. The one or more computer devices include at least one processing unit. The at least one computer device is configured to determine a vendor quality rating, providing bidding segmentation or provide customer feedback blocking. Methods of providing vendor quality ratings, bidding segmentation or customer feedback blocking are also provided.

### CROSS-REFERENCE TO RELATED APPLICATIONS

This application is a continuation of U.S. Pat. No. 12/509,916, filed Jul. 27, 2009 and also claims the benefit under 35 U.S.C. §119(e) of U.S. Provisional Patent Application Ser. Nos. 61/084,375, 61/193,025, 61/193,990, and 61/202,684.

### FIELD OF THE INVENTION

The present invention relates to online marketplaces and devices and systems configured to host or provide such online marketplaces.

### BACKGROUND OF THE INVENTION

Marketplaces are provided in computer networks or other networks such as the internet. Examples of marketplaces are operated by the likes of Ebay or Amazon.com at a particular website. The websites that host such marketplaces are hosted by computer devices, such as a server that is connected to various clients by at least one network connection. For instance, the server that hosts the website for an online marketplace may have an internet connection or a connection to a network that is interconnected to the internet.

Certain online marketplaces exist that offer a customer, such as a buyer, an opportunity to solicit quotes from vendors, such as sellers or freelance independent contractors. Such a website may be found on the internet at www.guru.com or at www.elance.com or www.odesk.com. Such online marketplaces may only measure and evaluate sellers based on cumulative earnings of work conducted with buyers via a relationship initiated through the online marketplace. Sellers may also be evaluated by qualitative statements from past buyers that may be in the form of comments posted on a message board or graphic icons representing a subjective measurement of quality. Such qualitative statements may be viewed on a webpage of the online marketplace website.

Vendors such as sellers can and, in some cases do, provide misleading information for such vendor quality rating systems that misrepresents a vendor's quality. For instance, vendors can mislead ranking systems based on gross earnings by artificially inflating earnings by creating false buyer accounts and falsely awarding phantom projects to their own vendor account. Similarly, sellers or other vendors may create false customer feedback, such as false buyer feedback. Such false customer feedback may include comments regarding a seller's quality or disparaging comments relating to a competitor's service quality.

Further, customer feedback statements can often be unreliable due to anomalies that are inherent to business relationships. For instance, a seller and buyer may experience a miscommunication regarding the buyer's desires or what services or products a seller's quote may include or what services or products a buyer actually desires. Most feedback models utilized by online marketplaces either provide no control over buyer feedback or fail to contain or prevent inaccurate feedback from being displayed to others.

Skill tests may also be employed by online marketplaces to provide some guide as to vendor quality, such as seller quality. Such tests fail to measure the more tacit qualities of a vendor that impact the full customer experience such as relationship management and product or service delivery. Further, skill tests are designed to appeal to a wide audience, which limits the ability of the skill test to capture the full breadth and depth of a vendor's talent or skill level. Moreover, skill tests are often self-proctored. As a result, a vendor, such as a seller, may easily cheat on such a test without being caught. Thus, customers, such as buyers, often place little confidence in the validity of the skill test scores.

An online marketplace is needed that provides an objective vendor quality assessment system. Such a system preferably relies on objective data and makes it difficult for a seller or other vendor to cheat or “game” the system to provide a misleading vendor quality rating. An online marketplace is also needed that provides buyers and other customers with an ability to review accurate customer feedback relating to a vendor's quality.

### SUMMARY OF THE INVENTION

An apparatus configured to host a marketplace on at least one network is provided. A method of providing such an apparatus is also disclosed. The apparatus includes at least one computer device configured to communicate with a plurality of clients via at least one network. The one or more computer devices include at least one processing unit. The clients may include vendors and customers. The vendors may be sellers seeking to offer or provide services or products and the customers may be buyers seeking to buy or obtain services or products. The at least one computer device is configured to determine a vendor quality rating, provide quote submission acceptability or provide customer feedback blocking. Methods of providing vendor quality ratings, quote submission acceptability or customer feedback blocking are also provided.

One embodiment of my apparatus includes at least one computer device configured to communicate with clients via at least one network connection. The clients include vendors and customers. The one or more computer devices include at least one processing unit and at least one memory. The at least one memory has at least one database containing vendor identifiers and vendor data. The vendor data may include earning information, customer identifiers and customer relationship information. The one or more processors are configured to determine a quality rating for each vendor. The vendor quality rating is determined by a method of calculating the quality rating processed by the one or more processing units. The method of calculating the quality rating includes selecting a first time period, accessing the one or more memory and determining at least one of a customer retention value for the first selected time period, a customer earning value for the first selected time period, and a customer acquisition value for the first selected time period.

The calculation of the vendor quality rating may include multiplying the customer acquisition value for the first selected time period by the customer earnings value for the first selected time period or the customer retention value for the first selected time period. The calculation of the vendor quality rating may alternatively include multiplying the customer earnings value for the first selected time period by the customer acquisition value for the first selected time period or the customer retention value for the first selected time period. As yet another alternative, the calculation of the vendor quality rating may include multiplying the customer retention value for the first selected time period by the customer earnings value for the first selected time period or the customer acquisition value for the first selected time period. It should be appreciated that a customer acquisition value may be a buyer acquisition value, that the customer earnings value may be a buyer earnings value or that the customer retention value may be a buyer retention value.

As yet another alternative, the calculation of the vendor quality rating may include multiplying the customer retention value for the first selected time period or the customer earnings value for the first selected time period or the customer acquisition value for the first selected time period by a coefficient to produce a weighted customer retention value, a weighted customer earnings value, or a weighted customer acquisition value. In embodiments where all of these values are weighted, the weighted values may all be multiplied together to determine a vendor quality rating. In other embodiments where only one of the values is weighted or only two of the values are weighted, the weighted values may be multiplied by the non-weighted values to determine a vendor quality rating.

Preferably, the one or more memory is operatively attached to the at least one processing unit and the first time period is selected by accessing a time period stored on the memory. For instance, a memory may be communicatively coupled to a processor and may have a time period stored as a variable for use in a program processed by the processor that defines the first selected time period. Preferably, the first selected time period is a three month time period, a six month time period, a nine month time period, a twelve month time period, a fifteen month time period, an eighteen month time period, a twenty-one month time period or a twenty-four month time period. It should be appreciated that different units of time for the first selected time period or any other time period discussed herein may also be used for the time periods such as seconds, days, or years.

Some embodiments of my apparatus may also be configured to provide bidding segmentation. For instance, one embodiment may include one or more processing units that are configured to determine quote submission acceptability for a vendor by a processing method that includes determining a number of bids the vendor received for a second selected time period, determining a cost of bids for each quote submitted by the vendor within that second selected time period, and determining a remaining number of bids for the vendor within the second selected time period. The one or more computer devices are configured to not permit bidding by the vendor when the cost of bids submitted by the vendor for a quote within the second selected time period is effectively greater than the remaining number of bids for the vendor within the second selected time period. It should be understood that the second selected time period may be a shorter or longer period of time than the first selected time period or may be the same time period as the first selected time period.

Preferably, the cost of bids for each quote submitted by a vendor within a time period is determined by the one or more processing units processing a cost of bids calculation method that includes determining a type of quote submitted by the vendor within the second selected time period and determining the bid cost for the type of quote. The type of quotes may include standard quotes and one or more premium quotes. The bid cost for a standard quote is effectively less bids than the bid costs for one or more of the premium quotes or all of the premium quotes.

The number of bids a vendor may be allocated for the second selected time period may be determined so that a vendor with a better quality rating has a lower cost of bids than a vendor with a lesser quality rating. For instance, a vendor that has a first quality rating that is a high value that correlates with a better quality rating may have a lower cost of bids than a vendor with a lower quality rating. As another example, a vendor that has a first quality rating that is a low value that correlates with a better quality rating may have a lower cost of bids than a vendor with a higher quality rating.

Embodiments of my apparatus may also be configured to receive and communicate feedback for the vendors such that the feedback is displayable to customers. In one embodiment of my apparatus, the one or more computer devices can be configured to provide feedback such that the vendors are permitted to block a portion of the feedback customers transmitted to the one or more computer devices such that the received feedback is not viewable or otherwise disclosed to other customers.

The portion of the feedback a vendor is permitted to block can be determined by assigning a feedback block rate or a feedback block amount to the vendor. The feedback block rate or feedback block amount can be correlated with the vendor quality rating such that a vendor with a better quality rating is permitted to block more feedback than a vendor with a worse quality rating. For instance, a feedback block rate or feedback block amount to a vendor can be assigned to a vendor based on the quality rating for that vendor. A vendor that has a first quality rating that is a high value that correlates with a better quality rating may have a greater block rate or greater block allowance than a vendor with a lower quality rating. Alternatively, a vendor that has a first quality rating that is a low value that is correlated with a better quality rating may have a greater block rate or greater block allowance than a vendor with a higher quality rating.

Preferably, the feedback block allowance for a vendor is determined by multiplying the cumulative earnings of the vendor within a third selected time period by a block allowance rate. The block allowance rate can be assigned such that a vendor with a better quality rating receives a greater block allowance rate than a vendor with a worse quality rating. It should be appreciated that the third selected time period may be the same or different than the first selected time period or the second selected time period.

It should be appreciated that embodiments of my apparatus may include a group of customers that have a certain customer classification. That customer classification may be a classification that permits the customer to be excluded from a feedback block allowance. For instance, a seller may be prohibited from blocking feedback communicated by a certain buyer with certain buyer data that defines or identifies that buyer as being able to provide feedback that cannot be blocked. For example, the data can identify the buyer as being within an unblockable class of customers.

Preferably, the one or more computer devices may be one or more servers or one or more workstations and the one or more processing units are a program configured for processing by the computer device, a central microprocessor, a server microprocessor or a processor that is composed of one or more semiconductors. Preferably, embodiments of my device are configured to permit free lance contractors to bid on request for proposals submitted by customers and is also configured to communicate with clients via internetworking.

One embodiment of my apparatus includes at least one computer device configured to communicate with clients via at least one network connection. The clients include vendors and customers. The one or more computer devices include at least one processing unit and at least one memory. The at least one memory has at least one database containing vendor identifiers and vendor data. The vendor data includes earning information, customer identifiers and customer relationship information. The one or more processors are configured to determine a quality rating for each vendor. The vendor quality rating is determined by a method of calculating the quality rating processed by the one or more processing units. The method of calculating the quality rating includes selecting a first time period, a second time period and a third time period, accessing the one or more memory and determining at least one of a customer retention value for the first selected time period, a customer earning value for the second selected time period, and a customer acquisition value for the third selected time period. The first selected time period is a different time period than the second or third selected time period.

In some embodiments of my apparatus, the customer acquisition value may be determined by dividing a number of projects awarded to a vendor by new clients by a number of valid quotes submitted by that vendor. The valid quotes and the awarded projects are not counted for quotes submitted to a customer after a first project is awarded to the vendor by that customer.

In other embodiments of my apparatus, the customer earning value for each vendor can be calculated by determining an average customer earning rate for the vendor. The customer earning rate for each customer is determined by dividing earnings the vendor received from that customer by a portion of the selected time period in which the vendor and that customer had a relationship to identify an average earning rate for that customer. The average earning rates for each customer are added together to identify a total average earning rate, which is divided by the number of customers for the vendor to identify a vendor average earning rate.

In yet another embodiment of my apparatus, a customer retention value for the first selected time period can be calculated by determining a customer earning rate for a customer within the first selected time period for each customer of a vendor in the first selected time period. The customer earning rates within the first selected time period for each customer of the vendor may be added together to identify a total customer earning rate for the vendor. The customer earning rate for each customer of the vendor may be divided by the total customer earning rate to identify an average customer earning rate for each customer of the vendor for the first selected time period. The average earning rate for each customer of the vendor may then be multiplied by a relationship time period to determine a customer retention rate for each customer of the vendor for the first selected time period and the customer retention rate for each customer of the vendor may then be added together to determine a total customer retention rate for the first selected time period for the vendor. The total customer retention rate may be the customer retention value. The relationship time period is a time period in which the vendor and a customer had a relationship and is preferably not limited to being within a selected time period.

Embodiments of my apparatus may also only be configured to provide bidding segmentation, feedback blocking or both bidding segmentation or feedback blocking.

For instance, an embodiment of my apparatus may include one or more computer devices configured to communicate with a plurality of clients via at least one network connection. The one or more computer devices may include one more processing units configured to determine quote submission acceptability for a vendor by a processing method that includes determining a number of bids the vendor receives for a tie period, determining a cost of bids for each quote submitted by the vendor and determining the number of bids for the vendor within a selected time period. Quote submissions are not permitted by a vendor when the cost of bids submitted by the vendor for a quote within a selected time period is effectively greater than the remaining number of bids for the vendor within the selected time period.

The one or more computer devices may include one or more memory that is accessible by the one or more processing units. The at least one memory has vendor data that includes the remaining number of bids for the vendor, the cost of bids for the vendor and the number of bids the vendor received for the selected time period.

The one or more processing units may also be configured to prohibit quote submissions by a vendor when the cost of bids submitted by the vendor within the selected time period is effectively in excess of the remaining number of bids the vendor received for the selected time period.

Preferably, the one or more processing units are configured such that the number of bids the vendor initially receives is replaced with the determined remaining number of bids after a vendor quote is submitted. For example, the number of bids the vendor receives for the selected time period can be replaced with the remaining number of bids value of bids such that the cost of bids for subsequent quote submissions by the vendor further reduces the number of remaining bids value for the vendor within the selected time period.

Embodiments of my apparatus may also be configured for feedback blocking. For instance, my device may include one or more computer devices that include at least one processing unit. The one or more processing units can be configured to provide feedback for the vendors such that the feedback is displayable to customers and may also be configured to permit vendors to block a portion of feedback the customers transmitted to the at least one computer device. The portion of the feedback a vendor may block is determined by assigning a feedback block rate that is correlated with a vendor quality rating or a feedback block amount that is correlated with a vendor quality rating.

It should be appreciated that embodiments of my apparatus may include one or more memory operatively attached to the one or more processing units. The one or more memory may include vendor data. The vendor data may include the vendor quality rating, the block rate for each vendor, or a block allowance for each vendor.

Methods of providing a marketplace on at least one network are also provided. One embodiment of my method includes offering a marketplace hosted by one or more computer devices configured to communicate with the clients via at least one network connection. The one or more computer devices include at least one processing unit. The one or more processing units are used to determine a vendor quality rating for each vendor. The vendor quality rating is determining by the at least one processor selecting a first time period and determining at least one of a customer retention value for the first selected time period, a customer earning value for the first selected time period and a customer acquisition value for the first selected time period.

Embodiments of my method may also include providing or offering bidding segmentation. The bidding segmentation may be provided by the at least one processor processing a quote submission acceptability method. One embodiment of a quote submission acceptability method includes determining a number of bids a vendor receives for a second selected time period, determining a bid cost for each quote submitted by the vendor and determining a remaining number of bids for the vendor within the second selected time period. The vendor may not be permitted to submit a quote when the cost of bids submitted by the vendor for a quote within the second selected time period is effectively greater than the remaining number of bids for the vendor within the second selected time period.

My method may also include providing a system to receive or transmit feedback for vendors. The system is provided such that the vendors are permitted to block a portion of the feedback customers transmitted to the at least one computer device. The one or more processors of the at least one computer device may be able to determine the amount of feedback a vendor may block based on different blocking determination methods. For example, the one or more processors can be configured to assign a feedback block amount in correlation with the vendor quality rating of the vendor such that a better quality rated vendor receives more blocking ability than a vendor with a worse quality rating. As another example, a block allowance or block capacity, may be determined by multiplying cumulative earnings of the vendor within a first selected time period by a block allowance rate. The vendor may then block customer feedback from customers that dealt with the vendor on projects until the value of the projects the customers were involved in are equal to or greater than the blocking capacity amount.

Another embodiment of my method includes offering a marketplace hosted by one or more computer devices configured to communicate with the clients via at least one network connection. The one or more computer devices include at least one processing unit. The one or more processing units are used to determine a vendor quality rating for each vendor. The vendor quality rating can be determined by the at least one processing unit selecting at least one of a first time period, a second time period and a third time period and determining at least one of a customer retention value for the first selected time period, a customer earning value for the second selected time period and a customer acquisition value for the third selected time period.

It should be understood that the first selected time period is a different time period if the amount of time is different than the amount of time represented by the second selected time period or the third selected time period. For instance, the first selected time period is a different amount if it identifies three days as a time period and the second or third selected time period identifies two days. However, the first selected time period does not differ from the second selected time period if the first selected time period is equivalent to three hours and the second selected time period is equivalent to one hundred eighty (180) minutes.

It should be understood that embodiments of my apparatus or embodiments of my method may be configured to include various combinations of the vendor quality rating calculation options, bidding segmentation options or feedback blocking options discussed above.

Other details, objects, and advantages of the invention will become apparent as the following description of certain present preferred embodiments thereof and certain present preferred methods of practicing the same proceeds.

### BRIEF DESCRIPTION OF THE DRAWINGS

Present preferred embodiments of apparatuses configured to host or provide an online marketplace and methods of providing such apparatuses and services offered by the marketplace hosted by such apparatuses are shown in the accompanying drawings in which:

FIG. 1 is a diagram of a first present preferred online marketplace hosted by a first present preferred embodiment of a computer device configured to host such a marketplace.

FIG. 2 is a diagram of a second present preferred online marketplace hosted by a second present preferred embodiment of a computer device configured to host such a marketplace.

FIG. 3 is a diagram of a third present preferred online marketplace hosted by a third present preferred embodiment of a computer device configured to host such a marketplace.

FIG. 4 is a diagram of a fourth present preferred online marketplace hosted by a fourth present preferred embodiment of a computer device configured to host such a marketplace.

FIG. 5 is a perspective view of a present preferred embodiment of a computer device that can be configured to host an online marketplace.

FIG. 6 is a flow chart demonstrating a present preferred method of determining a present preferred customer acquisition value.

FIG. 7 is a flow chart illustrating a present preferred method of determining a present preferred customer earnings value.

FIG. 8 is a flow chart showing a present preferred method of determining a present preferred customer retention value.

FIG. 9 is a flow chart illustrating a first present preferred method of determining a first present preferred vendor quality rating. An optional step fro ranking the vendors based on the vendor quality rating raw scores is shown in dotted line.

FIG. 10 is a flow chart showing a second present preferred method of determining a second present preferred vendor quality rating.

FIG. 11 is a flow chart demonstrating a present preferred method of providing bidding segmentation.

FIG. 12 is a flow chart illustrating a present preferred method of determining a cost of bids for a quote submitted by a vendor.

FIG. 13 is a flow chart demonstrating a present preferred method of providing customer feedback.

FIG. 14 is a flow chart showing a present preferred method of determining a portion of feedback that a vendor may block.

### DETAILED DESCRIPTION OF PRESENT PREFERRED EMBODIMENTS

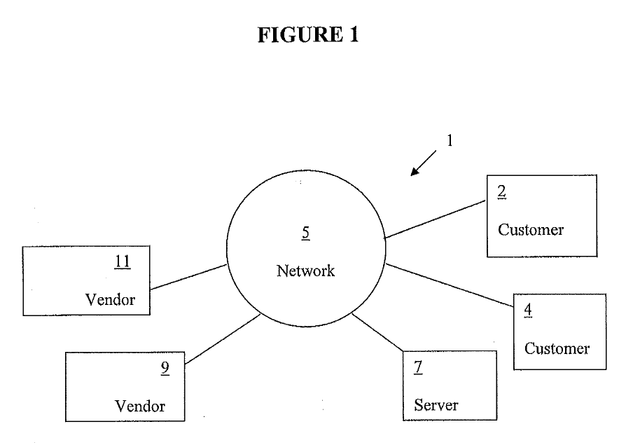

Referring to FIG. 1, a first present preferred online marketplace 1 is shown. The marketplace 1 is hosted by a server 7 that is connected to a network 5, such as a global network of interconnected devices like the internet. The server 7 is preferably configured to communicate to clients via internetworking through a network connection. Clients to the marketplace 1 may include a plurality of customers that include customer 2 and customer 4 and a plurality of vendors that include vendor 9 and vendor 11. The vendors may be service providers such as carpenters, contractors, plumbers, artists, lawyers, or other service providers that communicate with the marketplace via a computer or other device. The vendors may also be considered sellers. The customers may be people or companies that need or want a particular service rendered or a product provided to the customer. The customers may also be considered buyers or potential buyers. The customers may communicate with the server 7 via a computer, personal digital assistant, cellular phone or other device connected to the network 5 such that the device can send and receive data from the server 7.

The server 7 is preferably configured to host a marketplace for freelancer vendors and customers that would be potential customers for the vendors. The server is configured to store data concerning transactions that take place between the customers and vendors and also access that data to provide services or make determinations or calculations relating to vendor or customer activities. The data may be stored in memory of the server. For instance, the data may be stored in databases that are located in memory of the server 7. Of course, the data relating to vendor and customer interactions may also or alternatively be stored in memory connected to or connectable to the server such as memory in a backup server or memory in a secondary device that is connectable to the server 7.

The server 7 is configured to access and assess the stored data to determine a vendor quality score. The vendor quality score is preferably based on objective measurable values obtained or measured from events that take place via the marketplace, such as financial transactions or business arrangements that take place via the marketplace. For instance, the vendor quality score may be based on a vendor's customer acquisition rate, customer earnings rate, and customer retention rate. Such rates may be calculated cumulatively or for a subset period of time such as annually or quarterly. It should be understood that the server can be configured to recalculate these rates every day, every week, every month or every year so that time periods are not limited to calendar weeks, calendar months or calendar years.

Vendor performance can change over time. For instance, a vendor that has good quality over a period of five years may perform poorly in a sixth year. Consequently, I prefer that the server be configured to determine a vendor quality rating or vendor quality score for a vendor's activates that took place over the past 3 months, six months, nine months, or twelve months from the date on which a customer may view the vendor rating for a particular vendor. Such a determination may require the calculation of a customer acquisition rate, customer earnings rate, and customer retention rates to be recalculated daily.

The server 7 may also be configured to provide a bidding system that decreases the cost of responding to a customer solicitation for a quote in proportion or an inverse proportion to a vendor's quality score. The server 7 may also be configured to provide a feedback system for customer feedback that increases a vendor's ability to filter customer feedback in proportion to a vendor's quality score or quality rating. It should be understood that such a quality score or rating may be a raw score or a ranking based on a sort of a vendor quality rating raw scores.

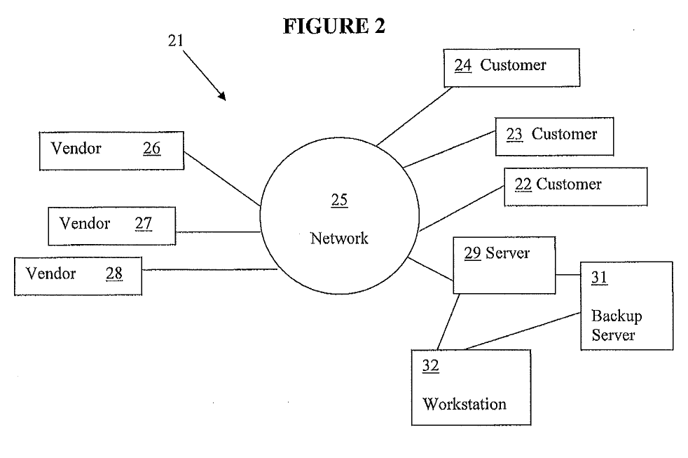

Referring to FIG. 2, a second present preferred marketplace 21 may be hosted by a server 29 and a backup server 31. The server 29 and backup server 31 may be owned by a marketplace provider or an Internet service provider that has an agreement with the marketplace provider to store and maintain the server that runs programming owned by the marketplace provider. The marketplace provider may have a computer or workstation 32 that can access the server 29 or backup server 31 to update, maintain or operate the programming that hosts the marketplace.

The server 29 or backup server 31 may be configured to connect to at least one network 25 to communicate with a plurality of clients such as customers 22, 23 and 24 and vendors 26, 27 and 28. It should be understood that the customers may be buyers or prospective buyers of products or services and the vendors may be sellers or providers of products or services.

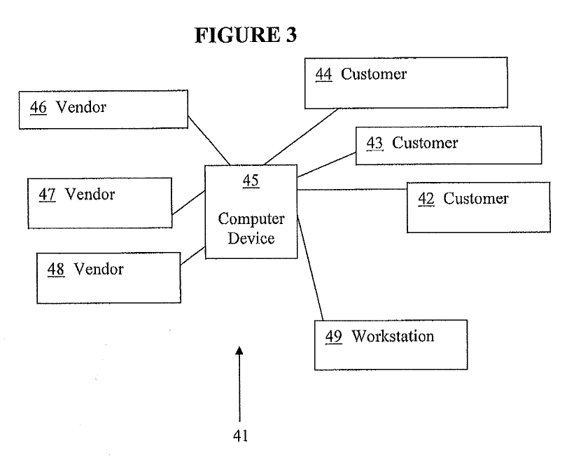

As shown in FIG. 3, an embodiment of my marketplace 41 may be hosted by computer device 45 that forms a network with a number of clients such as customers 42, 43 and 44 and vendors 46, 47, and 48. The computer device may be a server, a workstation or interconnected servers or workstations configured to host a marketplace via one or more networks. The computer device 45 may also be connected to a computer or workstation 49 that is configured to update the website or network hosting services offered by the computer device 45. It should be understood that such a connection may be a direct network connection or may be an internetworking connection.

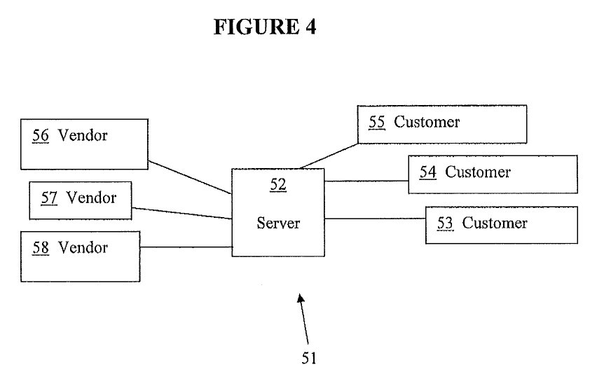

As may be appreciated from FIG. 4, embodiments of my marketplace 51 may also include a localized network that is hosted by a server 52 connected to multiple clients such as customers 53, 54 and 55 and vendors 56, 57 and 58 via typical networking connection mechanisms or networking devices. The customers may be buyers of products or services and the vendors may be sellers or products or services. It should be understood that such a marketplace 51 may have the server 52 configured for an intranetworking connection to the clients.

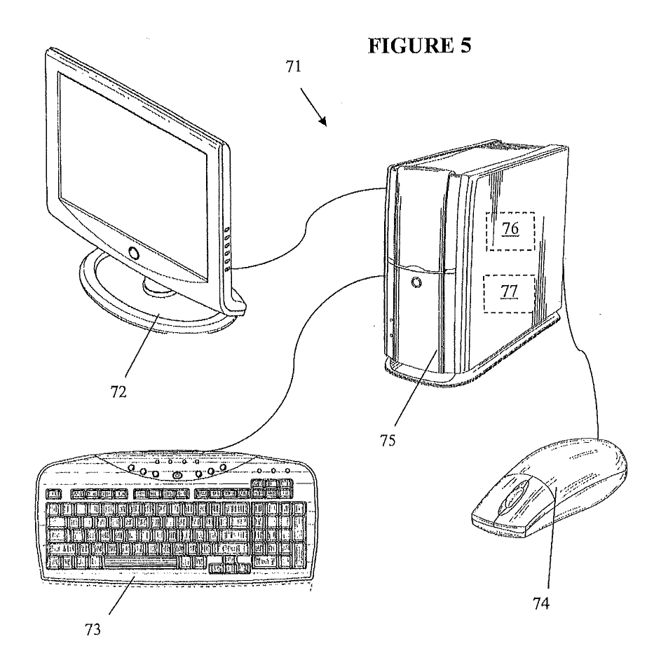

A present preferred computer device 71 that may host an embodiment of my marketplace is shown in FIG. 5. Preferably, the computer device 71 includes a display device 72 and data input components such as a keyboard 73 and mouse 74 that are connected to a hub 75 that includes a central processing unit 76 operatively or communicatively connected to at least one memory 77. The central processing unit 76 may include one or more microprocessors 76, one or more server microprocessors, and one or more processors that include at least one semiconductor. The memory 77 may have one or more programs stored thereon that are executed by the one or more microprocessors 76. The one or more programs may define certain methods that are processed by the microprocessor or microprocessors that run the program. The defined methods may define operations for services offered by the marketplace or may be configured to calculate or determine a vendor quality rating, operate bidding segmentation or operate or oversee customer feedback blocking.

The memory 77 may also contain one or more databases that contain data such as, for example, vendor identifiers that identify each vendor of the marketplace hosted by the computer device 71 and other vendor data. For example, the memory 77 may have earning information for each vendor, customer identifiers that identify customers or buyers that have interacted with a vendor or used the marketplace hosted by the computer device, or customer relationship information. The vendor data may also include vendor quality data, customer feedback transmitted to the computer device 71, block allowance rates or block allowances for a vendor, or other data. The vendor data may also involve data used to determine a vendor quality rating that is discussed more fully below.

Of course, the vendor data may also include other data related to interactions between customers and vendors that have been initiated via the marketplace or otherwise involved use of marketplace resources. For example, one or more servers or other computer devices configured to host an online marketplace may be configured to store data on the interactions between customers and vendors. Such data may include vendor earnings for each quote that a customer accepted from that vendor, cumulative earnings the vendor made from projects he received through quotes submitted on the online marketplace, customer feedback that may be submitted to the device and subsequently stored such that the feedback is displayable to others and other data. One or more programs may be stored on the server or run on the server to collect such data, use such data or ensure the data is properly stored.

The one or more computer devices configured to host a marketplace can be configured to determine a vendor quality rating such as a vendor quality raw score or vendor quality ranking for each vendor. The vendor quality rating is configured to compare one vendor's performance against the full population of like vendors that have used the marketplace. Such a raw score may be determined by calculating a raw score based on various parameters such as a customer acquisition value, a customer earnings value and a customer retention value. A vendor ranking may be a ranking of each vendor based on the vendor's position within a sort of the vendor raw scores based on ascending or descending order of those scores. Such a ranking may be placed numerically or in percentage terms (e.g. the vendor has the third best rating or is among the top 8% of vendors).

Customer Acquisition Value Determinations

A customer acquisition value is configured to objectively measure a vendor's ability to acquire customers. One embodiment of a customer acquisition value is a buyer acquisition value that objectively measures a seller's ability to acquire buyers. The customer acquisition value may be a customer acquisition rate that is configured to measure the number of new customers that place orders with a vendor in a selected time period. The customer acquisition rate may be calculated for a cumulative time period, but is preferably calculated for a subset time period such as a one year time period. For instance, a measure of customer acquisition can be based on the total number of valid quotes submitted by a vendor. A valid quote being a quote submitted in response to a customer solicitation for a quote that resulted in a paid invoice to a vendor that submitted a quote accepted by the customer. The vendor's average quote acceptance may then be calculated. The number of projects awarded to that vendor is then divided by the number of total valid quotes submitted by the vendor. The below equation may be used to provide a customer acquisition value as a customer acquisition rate (also referred to herein as “CAR”):

$$C A R = \frac{\begin{matrix}number of projects awarded to a vendor as a result of \\ a submitted valid quote\end{matrix}}{number of valid quotes submitted by the vendor}$$

The one or more computer devices configured to host an online marketplace may be configured to consider a number of parameters to determine a customer acquisition value. For instance, only a vendor's most recent valid quotes by date or time of submission under one or more profiles within a single main skill category may be evaluated during the determination of the customer acquisition value. As an example, a vendor that offers multiple skills such as computer programming and carpentry may have a customer acquisition value determined for the projects related to only computer programming or only carpentry. The vendor may also have an overall customer acquisition value that takes into account the vendor's performance in all the projects awarded to that vendor regardless of the skill category the vendor's services may fall within.

Occasionally, only one half of a project will be recorded by the one or more computer devices hosting the marketplace. For instance, a vendor or customer may only communicate the paid invoice for a project. In such circumstances, the one or more computer devices can be configured to count the paid invoice as an awarded project and also add that project to the number of valid quotes submitted by the vendor.

The number of valid quotes submitted by a vendor may have a set maximum limit for calculating or determining a customer acquisition value. For instance, the number of valid quotes submitted by the vendor may be considered to be a maximum of 70 or 200 quotes even if the vendor submitted more than 70 or 200 quotes. In the event a vendor has submitted more than the maximum number of quotes, the number of awarded projects can be adjusted to reflect that the projects were awarded as a result of the vendor's most recent maximum number of valid quotes. Alternatively, the vendor's awarded projects may be normalized to adjust that number of awarded quotes downward to reflect the number of awarded quotes that would have been awarded to the vendor for the defined maximum number of valid quotes.

Further, a minimum number of valid quotes may be set for the number of valid quotes submitted by the vendor value used to determine the CAR. For example, a vendor that only submitted eight quotes within a time period may be considered to have submitted the minimum number of valid quotes if that minimum number is greater than eight. If the minimum number is twenty-five quotes, for example, than the vendor will be considered to have submitted twenty-five quotes for determining the customer acquisition value even if that vendor submitted less than twenty-five quotes. Preferably, a minimum number of valid quotes is within a range of twenty-five to fifty valid quotes.

It should be appreciated that the minimum and maximum values for the total number of submitted valid quotes can be used to help normalize vendor activity.

What constitutes a valid quote submitted by a vendor may be different. For instance, the number of valid quotes may include all the valid quotes submitted by the vendor. I prefer, however, that the customer acquisition value by a CAR for new customer acquisition. Therefore, I prefer that the number of valid quotes submitted by a vendor be counted such that the total number of valid quotes value is the number of quotes submitted by a vendor to customers that the vendor has previously not done business with within the selected time period. Once a customer accepts a first quote, any subsequent quotes submitted to that customer are not included within the total number of submitted valid quotes value. Further, the number of projects awarded to the vendor is only one project for any particular customer since any subsequently submitted quotes are not considered.

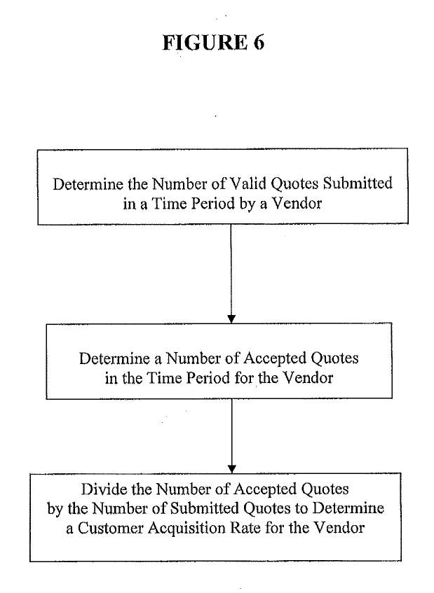

Examples of customer acquisition value calculations are provided below to help better describe the determination of such values discussed above with reference to the parameter considerations that may be made to make such determinations. An example of a method for determining a customer acquisition value as a CAR is also shown in the flow chart of FIG. 6. As may be appreciated from FIG. 6, a CAR may be determined by first determining a number of quotes submitted by a vendor within a time period and also determining the number of quotes that were accepted by a customer within that time period for the vendor. The number of accepted quotes may then be divided by the number of submitted quotes to determine a CAR for the vendor.

Examples of Customer Acquisition Value Determinations

For the below examples, the number of valid quotes maximum number is 100 and the minimum number is 40. Therefore, a number of valid submitted quotes below 40 will be considered to be 40 and the number of valid submitted quotes above 100 will be considered to be 100 for the below mentioned examples.

A vendor submits:

(1) 50 valid quotes and 15 projects are awarded to the vendor; the CAR equals 30% (15/50);

(2) 25 valid quotes and 10 projects are warded to the vendor; the CAR equals 25% (10/40);

(3) 12 valid quotes and 3 projects are awarded to the vendor, the CAR equals 7.5% (3/40);

(4) 120 valid quotes and 30 projects are awarded to the vendor and 25 of the projects were awarded in the most recent 100 valid quotes; the CAR equals 25%: (25/100);

(5) 200 valid quotes and 60 projects are awarded to the vendor, the awarded projects is normalized to the 100 valid quote maximum such that the CAR equals 30%: (30/100);

(6) 45 quotes are submitted to 41 different customers by a vendor and the vendor submitted three quotes within the time period to a customer A and three quotes within the time period to a customer B, customer A accepts the second and third of the three submitted quotes and customer B accepts the third of the three quotes submitted to that customer, fifteen other customers awarded the vendor projects on the remaining 39 quotes submitted to 39 different customers. The total number of valid quotes submitted within the time period is 44 quotes since only the vendor's second quote submission to customer A is counted in counting the quotes submitted to customer A. The total number of accepted valid quotes is 17 since the acceptance of the third quote by Customer A is not counted due to the previous acceptance of the second quote submitted to Customer A. Therefore, the vendor CAR is equal to 38.63% (17/44).

Customer Earnings Value Determinations

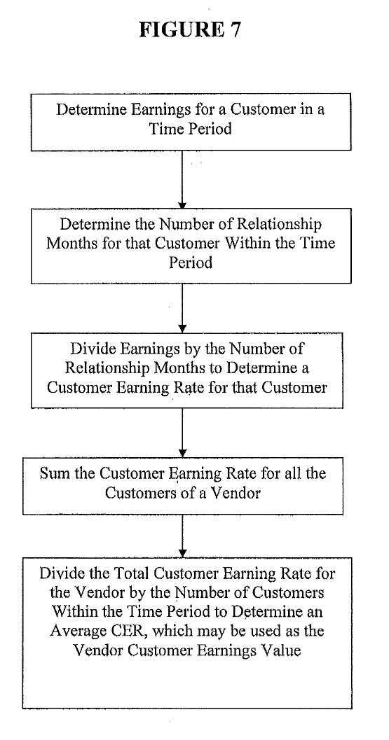

A vendor's customer earning value is configured to objectively measure the monetary value of a vendor's service over time. A vendor's customer earning value may be considered to be a seller's customer earning value that is configured to objectively measure the monetary value of a seller's services over time. The customer earning value is preferably configured to determine a vendor's customer earning rate as the average of a vendor's earnings per customer per month over a predetermined period of time within a range of between three months and two years. A present preferred method of determining a customer earnings value can be seen in FIG. 7.

The customer earnings value may be calculated as a customer earning rate (also referred to herein as a “CER”) for the vendor. The CER may be calculated by identifying a particular time period of data for using in the calculation. The time period is preferably between three months and twenty-four months. The cumulative earnings per customer can be divided by the number of relationship months per customer to identify an average cumulative earnings per customer for each customer of the vendor. The average cumulative earnings for each of the customers may then be added together to identify a total raw average cumulative earnings for the customers. This total raw average cumulative earnings for the customers' value may then be divided by the total number of customers that have paid an invoice within the time period (e.g. three months, six months, twenty-four months, etc.) to obtain an average earnings per customer per month value, which may also be the customer earnings value.

A mathematical formula describing the above discussed CER determination can be:

$$C E R = \frac{\begin{matrix}( SUM [ ( earnings per customer ) / ( number of \\ relationship months per customer ) ] )\end{matrix}}{\begin{matrix}total number of customers that paid an invoice \\ within the time period\end{matrix}}$$

A flow chart illustrating a present preferred method of making a CER determination is also provided in FIG. 7. As an example, the earnings (or revenue) a vendor received from a customer in a time period may be determined by accessing data relating to such transactions that have been recorded and saved. The number of relationship months the vendor has with that customer may also be determined based on accessing that same saved data. The month a first invoice is paid is considered a first relationship month within the time period and every month thereafter is an additional relationship month. The earnings received by the vendor from that customer in that time period is divided by the number of relationship months to determine a customer earning rate for that customer. Each customer earning rate for all the customers of the vendor within the time period is added together. That sum is then divided by the number of customers that the vendor had within the time period to determine an average CER. The average CER may be used as the vendor's customer earning value.

Various parameters may be taken into consideration when determining a customer earnings value for use in determining a vendor quality rating. For instance, only customers from whom a vendor has earned money in the time period (e.g. three months, six months, twenty-four months, etc.) are used in calculating the CER. Preferably a predetermined minimum number of relationship months is used for calculating the number of relationship months to ensure the integrity of the calculated values. For example, a three month or six month relationship months minimum value may be defined. A program or computer device may be configured to consider one or more such parameters in making a customer earning value determination or calculation based on stored data for a vendor.

A predetermined minimum number may also be utilized to calculate the total number of customers who have paid an invoice within the time period. Preferably, the minimum number is in the range of one through five customers. Such a minimum value also helps maintain the integrity of the calculated value by avoiding or mitigating one occurrence from having a disproportionate impact on a vendor's ranking or customer earnings value.

Preferably, the time period the cumulative earnings and customer relationships are measured for use in determining the average earnings per customer values and total number of customers that have paid an invoice values is between three months and twenty-four months. Of course, other time periods may also be used.

It should be understood that calculations or determinations of a customer earnings value may use different time units for a relationship time period. For instance, instead of relationship months, a determination may be made using relationship days or relationship weeks.

Examples of Customer Earnings Value Determinations

Table 1 illustrates an example calculation of a CER customer earning value. The time period for the calculations provided in the chart is one year, or twelve months. The columns identify the customer, the earnings (or revenue) the vendor received from each customer, the number of relationship months for the customer and a customer earning rate for that customer based on the number of relationship months for the customer, which is referred to as a “customer earning rate” in the table. The number of relationship months is the number of months since the vendor received its first paid invoice from each customer within the one year time period. Table 1 also shows a CER calculation of $560 and a total sum of customer earning rates of $2,800.

TABLE 1
First Example Of A CER Determination

| | EARNINGS | Number of | |
|---|---|---|---|
| | (within | Relationship | Customer Earning |
| CUSTOMER | the time period) | Months | Rate |
| A | $1,000 | 10 | $100 ($1,000/10) |
| B | $2,000 | 10 | $200 ($2,000/10) |
| C | $4,000 | 12 | $333 ($4,000/12) |
| D | $5,000 | 3 | $1,667 ($5,000/3) |
| E | $6,000 | 12 | $500 ($6,000/10) |
| SUM | | | $2,800 |
| CER | | | 2,800/5 = $560 |

Table 2 shown below shows another calculation of a customer earnings value, or buyer earnings value. This table includes a minimum number of relationship months as being three months and a minimum number of customers as being four buyers for making a CER determination. As may be appreciated from Table 2, the CER is $133.25 for the seller calculated according to the second example illustrated in Table 2.

TABLE 2
Second Example Of A CER Determination

| | | Number of | |
|---|---|---|---|
| | EARNINGS | Relationship | |
| BUYER | (within the time period) | Months | Buyer Earning Rate |
| A | $1,000 | 10 | $100 ($1,000/10) |
| B | $2,000 | 10 | $200 ($2,000/10) |
| C | $4,000 | 2 | $333 ($4,000/3) |
| SUM | | | $533 |
| CER | | | 533/4 = $133.25 |

Customer Retention Value Determinations

A customer retention value is configured to objectively measure a vendor's ability to satisfy customer requirements and sustain a relationship with the customer over time. One embodiment of a customer retention value is a buyer retention value that is configured to objectively measure a seller's ability to satisfy buyer requirements and sustain a relationship with the buyer over time. A customer retention value may be determined as a customer retention rate (also herein referred to as a “CRR”) that is determined by adding the vendor's retention rates per customer together. More specifically, a CRR may be determined by dividing the earning rate per customer by the sum of all earning rates to produce a rate of dollars earned per customer over a predetermined time period. Preferably, the time period is within the range of three months to twenty-four months.

A CRR may be determined by implementing the following calculation:

$$C R R = SUM \frac{\begin{matrix}[ ( ( earnings rate per customer ) \times \\ ( number of relationship months per customer )\end{matrix}}{( SUM [ ( earnings rates per customer ) ] ) ]}$$

Another formula that may define a CRR calculation is the following:

CRR=SUM[(percentage of earnings per customer)×(number of relationship months per customer)]

Yet another formula that may be used to define a CRR calculation for a seller or other vendor is the following:

$$C R R = SUM \frac{\begin{matrix}[ ( ( rate of earnings per buyer ) \times \\ ( relationship time period per buyer ) )\end{matrix}}{( SUM [ buyer earnings rates ] ) ]}$$

Various parameters may be considered in making a customer retention value determination. A program or computer device may be configured to consider one or more such parameters in making such a determination or calculation based on stored data for a vendor.

For example, only customers from whom a vendor has earned money in the time period may be included in the calculation of a vendor CRR. As another example, there may be a defined minimum number of customers or relationship months that are applied to making calculations used to determine the CRR or another customer retention value.

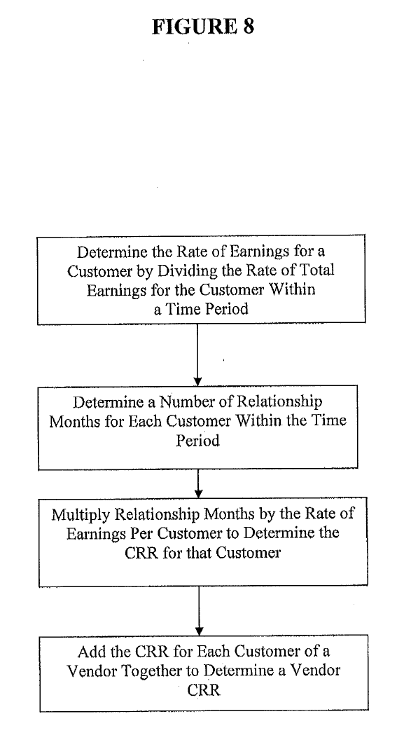

A present preferred method of calculating a customer retention value is also shown in FIG. 8. As may be appreciated from FIG. 8, a CRR may be determined by determining a rate of earnings for a customer by dividing the total earnings a vendor received from a customer by a selected time period. A number of relationship months the vendor has with that customer for the entirety of the customer-vendor relationship can be determined, counting the month the first invoice the vendor received from that customer as the first month of the relationship. The number of relationship months for the customer should be multiplied by the earnings rate for that customer to determine the customer CRR. All the customer CRRs for the customers within the time period are then added together to determine the vendor CRR. It should be understood that alternative methods of determining a vendor CRR can include determining earning rates based on other time units (e.g. days, months, seconds) and that the relationship months may also be substituted as other time units (e.g. relationship days, relationship seconds, etc.).

### Examples of Customer Retention Value Determinations

Table 3 illustrates an example calculation of a CRR customer retention value. The time period for the calculations provided in the chart is one year, or twelve months. The columns identify the customer, the earnings (or revenue) the vendor received from the customers, the number of relationship months for the customer throughout the entire relationship, a customer earning rate for that customer based on the number of relationship months for the customer, and a customer retention rate. The number of relationship months is the number of months since the vendor received its first paid invoice from each customer within the one year time period. Table 3 also shows a total CRR for the vendor as being 17.14 months and a total customer earning rate of $2,800 for the customers of the vendor.

TABLE 3
First Example Of A CRR Determination

| | | | | Customer |
|---|---|---|---|---|
| | Customer | | Number of | Retention |
| CUS- | Earning | Rate of Earnings | Relationship | Rate Per |
| TOMER | Rate | Per Customer | Months | Customer |
| A | $100 | 100/2800 = 0.036 | 10 | 0.36 |
| B | $200 | 200/2800 = 0.071 | 10 | 0.71 |
| C | $333 | 333/2800 = 0.119 | 40 | 4.76 |
| D | $1667 | 1667/2800 = 0.595 | 1 | 0.595 |
| E | $500 | 500/2800 = 0.179 | 60 | 10.71 |
| SUM | $2,800 | | | |
| | | | CRR | 17.14 |

As may be appreciated from Table 3, the customer retention rate for each customer can weigh the number of months a vendor has retained each customer over all time by the percentage of revenue earned from each customer per month within the one year time period. To determine relationship months, a first invoice paid at any time during a calendar month is counted as an invoice received in the first relationship month.

A second example CRR determination is provided below in Table 4. For this example, relationship month minimum values of six months and twelve months are defined. For relationship months that are between 6 months and 1 month, the relationship month value is six months. For relationship month values between 12 and 7 months, the relationship month value is twelve months. For relationship values over twelve months, the actual relationship month value is used. The time period selected for the review and assessment of saved customer and vendor data is one year, or twelve months. However, the number of relationship months is determined based on the length of the relationship the vendor had with each client and is not based on the selected time period of one year. The length of the relationship is considered to start the first month the vendor receives payment from the customer in the example illustrated in Table 4.

TABLE 4
Second Example Of A CRR Determination

| | | | Number of | Customer |
|---|---|---|---|---|
| | Customer | Rate of Earnings | Relationship | Retention Rate Per |
| CUSTOMER | Earning Rate | Per Customer | Months | Customer |
| A | $100 | 100/2800 = 0.036 | 10 | 0.43 (.036 * 12) |
| B | $200 | 200/2800 = 0.071 | 10 | 0.85 (0.071 * 12) |
| C | $333 | 333/2800 = 0.119 | 40 | 4.76 (0.119 * 40) |
| D | $1667 | 1667/2800 = 0.595 | 1 | 3.57 (0.595 * 6) |
| E | $500 | 500/2800 = 0.179 | 60 | 10.71 (0.179 * 60) |
| SUM | $2,800 | | | |
| | | | CRR | 20.32 |

Table 5 illustrates yet another example calculation of a vendor CRR. For the example shown in Table 5, a minimum relationship months value is set at 6 months and a maximum relationship month value is set as being 20 months. It should be appreciated that the time period for the determination of the CRR and customer earnings for the vendor is still one year, as used in the above first and second CRR examples.

TABLE 5
Third Example Of A CRR Determination

| | | | Number of | |
|---|---|---|---|---|
| | Buyer | | Rela- | |
| | Earning | Rate of Earnings | tionship | Buyer Retention |
| BUYER | Rate | Per Buyer | Months | Rate Per Buyer |
| A | $100 | 100/2800 = 0.036 | 10 | 0.36 (0.036 * 10) |
| B | $200 | 200/2800 = 0.071 | 10 | 0.71 (0.071 * 10) |
| C | $333 | 333/2800 = 0.119 | 40 | 2.38 (0.119 * 20) |
| D | $1667 | 1667/2800 = 0.595 | 1 | 3.57 (0.595 * 6) |
| E | $500 | 500/2800 = 0.179 | 60 | 3.57 (0.179 * 20) |
| SUM | $2,800 | | | |
| | | | CRR | 10.59 |

Vendor Quality Rating Determinations

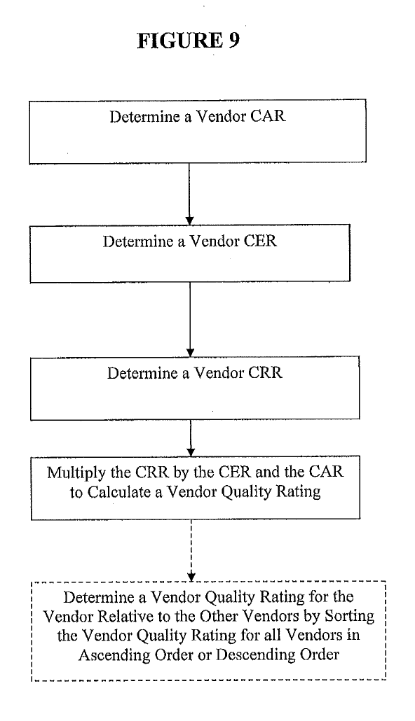

An objective vendor quality rating may be made by using one or more of the above discussed customer earnings value, customer retention value and customer acquisition value. For example a vendor quality rating or a seller quality rating could be obtained by multiplying a CAR by a CER and by a CRR (vendor quality rating=CER*CRR*CAR). As another example, a vendor quality rating could be obtained by multiplying the CER by the CRR, the CRR by the CAR or the CAR by the CER, as may be appreciated from FIG. 9. Of course, a vendor rating may also be determined by weighting one or more of the CRR, CAR, or CER values that may be used to calculate the vendor rating. As yet another example, the vendor quality rating could include multiplying or dividing one or more customer earning value, customer acquisition value or customer retention value with one or more other values that are based on other data that relates to vendor activities that took place via the online marketplace. Such data may be stored in memory of a computer device that hosts the marketplace or memory external to that device that can be communicatively coupled to that device.

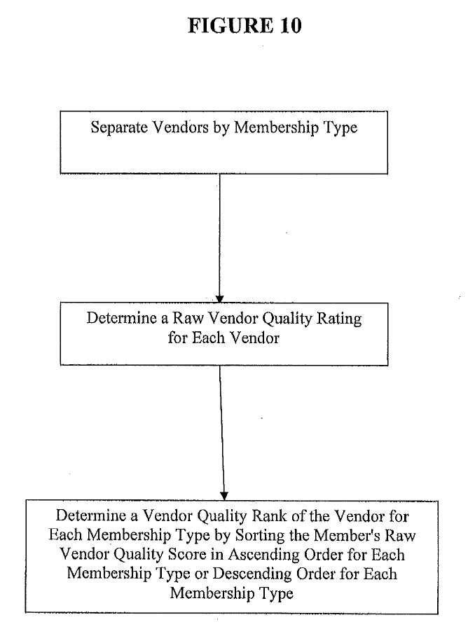

A ranking may be obtained for a vendor by sorting the vendors' raw quality rating score, as may be appreciated from FIG. 10. For instance, vendors 46, 47 and 48 of the marketplace hosted by the device 45 shown in FIG. 3 may each have a vendor quality rating raw score. That raw score may be sorted in ascending order or descending order. The rating may then be applied such that the vendor with the highest quality rating score is ranked first and the vendor with the lowest quality rating is ranked last. A vendor may have both a quality rating raw score and a ranking. It should therefore be appreciated that the vendor quality rating may be configured such that a vendor with a better quality rating has a higher rating value such as a raw score or a lower numerical value such as an ascending order of quality ranking (e.g. 1st of 100 vendors). The vendor rating may also be disclosed in percentage terms. For example, a seller that has the highest score out of a system that has one hundred vendors may be in the top 1% and the seller with the lowest rating of the one hundred vendors may be shown to be in the top 100% of vendors.

It should be understood that the vendor quality rating may be correlated with a quality level on different scales. For example, a vendor rating may be a numerically high value to represent a high quality of service such as a high raw score value to a calculation. Of course, the vendor rating may alternatively be a numerically low value to represent a high quality of service such as a #1 ranking or a top 1% percentile ranking. As yet another example, the vendor rating may also be established as a grade ranking by letter or other scale such that an “A” grade or other symbol correlates with a high quality rating and other grades or symbols correlated with lower quality ratings.

It should be appreciated that the composite vendor quality ratings discussed above can depict an objective measure of a vendor's success in customer acquisition, earnings and retention relative to the total population of vendors in the same main skill category, membership type or relative to all the vendors available through the marketplace. A computer device configured to host an online marketplace may host a website that includes a web page for each vendor that is a vendor quality related web page. That web page may display the quality rating of the vendor in percentage and raw scores. It may also display a percentile as to where the vendor ranks among other vendors in one or more skill categories or other categories. The webpage or a general description web page linked to the vendor quality related web page for each vendor will also describe how the vender rating values are determined.

The computer device may also be configured to provide sorting of vendors by quality ratings such as a vendor quality rating raw score. Such sorting can be provided for all vendors of the marketplace or to all vendors or sellers within a particular skill category or membership class offered by the marketplace. A customer or buyer may visit a webpage of the online marketplace hosted by a computer device and access a webpage that permits such sorting to better evaluate quotes received from different vendors for a project for which the customer solicited bids.

Of course, the computer device may also be configured to rank or rate vendors or sellers by other variables as well. For instance, the same vendor quality rating webpage or a separate one or more webpages associated with the vendor may include ratings or rankings of the vendor relative to the vendors' CER, CAR or CRR and compare the vendor's rates in these categories with other vendors by skill category, membership class, or total vendor population for the marketplace.

Bidding Segmentation

A computer device configured to host a marketplace such as the computer device 7 or server 29 shown in FIGS. 1 and 2 may also be configured to provide bidding segmentation. Bidding segmentation may be used to help reduce “spamming” responses to customers' requests for a quote. For instance, many vendors send a generalized or generic quote in responses to a request for a quote based on the underlying logic of the more quotes a vendor submits, the greater the probability the vendor will be awarded a project. Based on principles of probability, such an approach may seem justified to vendors and is certainly practiced by numerous vendors in online marketplaces.

However, I have determined that such an approach assumes that there is a correlation between the frequency of contacting a prospective customer and the customer's award of work. I have determined that such an approach overlooks a fundamental aspect of a customer relationship, a vendor's desire for work and desire to communicate that desire to a customer in earnest. I have determined that permitting vendors to pursue such spamming quote strategies in online marketplaces fails to meet customer needs or genuinely interested vendors' needs and, consequently, reduces the desirability of an online marketplace to the marketplace's clients. This is particularly true for marketplaces that are configured for establishing freelancer-customer business relationships.

I have found that the spamming approach used by numerous vendors in online marketplaces are detrimental to customers seeking earnestly interested vendors that want to work with a customer to meet the customer's needs. The spamming approach is also detrimental to the online marketplace as it may act to frustrate a customer that must sort through numerous duplicate quote submissions and may miss a genuinely interested vendor that has provided a quote that meets the customer's needs. Finally, the spamming approach is detrimental to detail oriented vendors that customize a quote to meet a customer's needs in an earnest attempt at building a customer relationship with a customer.

While vendor intent is abstract, it is possible to objectively measure and communicate such intent. Indeed, I have developed a system that can be utilized to provide a measurement of vendor intent related to the vendor's submission of a quote in response to a customer's request for a quote. Such a system is configured to align incentives for a vendor to become more in line with providing earnest, customized quotes that meet a customer's specifications provided in a quote request instead of mass produceable quotes that have little value to a customer. Preferably, the system is configured to inversely couple vendor pricing to vendor quality rating.

For example, a computer device may be configured to provide a vendor with different types of quotes to submit. A first type of quote may be a standard quote that has a relatively low cost to the vendor. A second type of quote may be a premium level quote that has a higher cost than the first type of quote. There may be additional premium types of quotes that are offered that have additional higher costs associated with those quotes as well. The cost involved in submitting a type of quote can indicate to the customer the level of interest the vendor has in working with the customer. The higher cost paid by the vendor for such quotes also ensures the vendor is more efficient in its allocation of vendor labor and will invest more time in improving the quality of the quotes that are made.

The bidding segmentation, which is configured to determine quote submission acceptability for vendors, may also be configured to take into account vendor quality. For example, the computer device hosting a marketplace can be configured to lower the cost of submitting standard and premium quotes to vendors with certain vendor quality ratings and raise the costs for such quotes to vendors with quality ratings that indicate low quality or poor service. For example, as a vendor's quality score increases to indicate better quality, a vendor's cost to respond to solicitation for a quote can decrease, which can provide an economic incentive to the vendor to improve its quality rating or provide better service to customers.

A computer device that is configured to host a marketplace can be configured to offer premium and standard quotes to vendors. Such quotes may be offered to vendors that purchase access to the marketplace or services hosted or operated by the computer device. For example, vendors may be required to have a membership class and may be permitted to choose between a free membership class and other membership classes that have prices that increase as the number of services provided to the vendors increase. For example, vendors that choose a membership class that is free may only be permitted to make standard quotes in response to a quote solicitation. Other vendors of more expensive membership classes may be permitted to make a standard quote and one or more different premium quotes.

The computer device may also be configured to ensure that a cost is paid by the vendor for each standard or premium quote submitted by that vendor. The cost may be “bids” associated with a particular type of quote. For instance, a standard quote may have a cost of one bid. A first premium quote may have a cost of two bids, and a third, highest premium quote may have a cost of four bids.

Each vendor may purchase a number of bids for use in a particular time period. For instance, a free membership may provide a vendor with forty bids to use per month, a first premium membership purchased by a vendor may provide the vendor with sixty bids to use per month. A second higher premium membership that can be purchased by a vendor may include one hundred bids to use in a month. A computer device can be configured to allocate a number of bids to a vendor within a time period based on the membership quality level the vendor purchases.

When a vendor responds to a quote solicitation submitted by a customer, the vendor spends at least one bid in submitting a quote. A vendor that has a free membership may only be permitted to use standard quotes. Such a vendor may, therefore, only be permitted to submit forty standard quotes within a time period, such as the one month time period. Every month, the vendor may be reassigned a number of bids so that the vendor starts each month with forty bids or less.

When a vendor that has a first premium membership submits a quote in response to a customer solicitation, the vendor may choose from the standard quote that costs one bid or a first premium quote that costs two bids. After each quote submission, the total number of available bids is reduced by the bid cost associated with each submitted quote. Once the bids allocated to that vendor are exhausted, the vendor may not submit additional quotes in response to a solicitation unless that vendor purchases a higher premium membership. Such a purchase may reset the number of bids available to the vendor. More preferably, the computer device is configured to provide the vendor with additional bids but subtract the bids already used within that time period from those allocated to the vendor when purchasing a more premium membership. Thus, a vendor that had a first premium membership and spent the sixty bids associated with that membership in the first two weeks of a month may only add another forty bids by purchasing the higher second premium membership.

The cost of bids may also be reduced by the vendor quality rating. For example, the cost of a first or second premium membership may be reduced for vendors that are within a particular vendor quality rating or ranking. Similarly, a vendor that has a low quality rating may pay an increased membership cost for such memberships.

In alternative embodiments, the cost of bids may be the same for all the vendors, but the number of bids allocated to a vendor may be adjusted based on the quality rating of the vendor. For example, a vendor with a better quality rating may receive more bids for a particular membership class than a vendor with a lower quality rating. By changing the number of bids allocated to vendors based on the quality rating of the vendors, the relative cost of submitting bids to the vendors is changed such that vendors with better quality ratings have a lower relative cost of submitting bids than vendors having a lower quality rating.

It should be appreciated that both the cost of bids and the number of bids assigned to a membership class purchased or acquired by a vendor can both be adjusted based on vendor quality ratings. For instance, a computer device configured to host a marketplace may be configured to adjust the cost of bids for submitting premium quotes or standard quotes to lower bid values for vendors having a better quality rating and may also be configured to assign more bids for a membership class than vendors having a lower quality rating that acquire that same membership class.

As a more concrete example, a computer device may be configured to assign forty bids to a first premium membership class to vendors of a better quality rating and may be configured to assign thirty-five bids to vendors that acquire that first premium membership class that have a lower quality rating. The computer device may also be configured such that the cost of bids for the vendor with the better quality rating is lower than the cost of bids for the other lower quality rating vendor when the vendors submit a premium quote or a standard quote.

Bidding Segmentation Examples

Table 6 illustrates a present preferred embodiment of distributing or offering memberships to vendors, such as sellers, and providing bid segmentation based on membership type.

TABLE 6
Example of Bidding Segmentation

| Membership Class | Bidding Segmentation Rules By Membership |
|---|---|
| First Premium Class | Vendor receives a number of bids per month within the range of |
| Vendor pays fee of more | 40-120 bids; |
| than $0 to online market | Vendors can elect to submit standard quotes or premium quotes; |
| provider | The cost to submit a standard quote is at least one bid; and |
| | The cost to submit a premium quote is based on the vendor |
| | quality rating of the vendor. Vendors with lower quality ratings |
| | incur higher prices than those that higher quality ratings. |
| Free Class | Vendors receive a number of bids within the range of 5-20 bids |
| Vendor pays fee of $0 to | per month; and |
| online market provider | Vendors only permitted to submit standard quotes. |

Table 7 illustrates a present preferred system for assigning a bid cost for premium quotes that may be utilized by a computer device configured to provide bidding segmentation for an online marketplace or marketplace hosted on an intranet or other network.

TABLE 7
Example Of Cost Of Bid Determination

| Quality Score | Bid Cost to |
|---|---|
| Percentile Rank For Vendor | Submit Premium Quote |
| Top 20% | 4 bids |
| Between 40% and 20% | 6 bids |
| Between 60% and 40% | 8 bids |
| Between 80% and 60% | 10 bids |
| Between 80% and 100% | 12 bids |

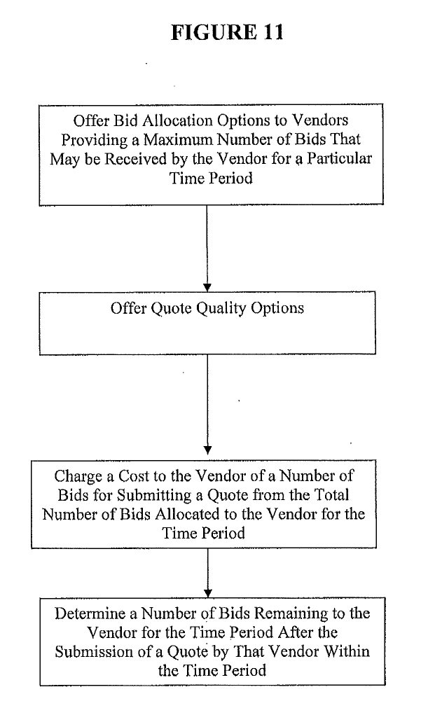

A flow chart illustrating a present preferred method of establishing quote submission acceptability for vendors may be found in FIG. 11. For instance, bid submission or quote submission options may be provided to a vendor that assigns a maximum number of bids to that vendor that the vendor may use in a particular time period. Quote options, such as standard and one or more premium quote options may also be provided for the vendor to choose from in submitting quotes to customers in response to quote solicitations. After a quote is submitted, the cost in bids for that quote is deducted from the number of bids assigned to that vendor to determine a remaining number of bids for the vendor. The vendor may not submit a quote if the bid cost for submitting the quote is higher than the number of remaining bids the vendor has within the time period. The vendor may acquire more bids when the time period ends and a new time period begins or by purchasing more bids by purchasing a membership or other service that offers more bids to the vendor.

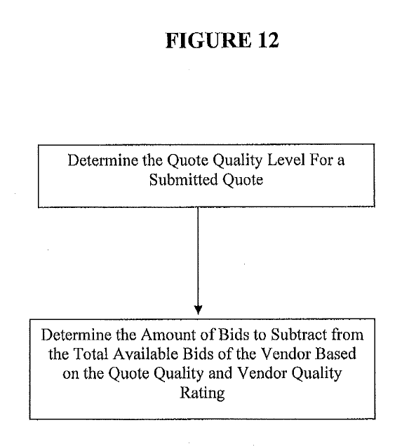

A flow chart showing a present preferred method of determining a bidding cost for submission of a quote is provided in FIG. 12. As may be appreciated from FIG. 12, one method of determining the bid cost for a quote is to determine the quality of a quote for each quote submitted by a vendor. The amount of bids that quote costs is determined based on the quote quality and that cost of bids is subtracted from the remaining number of bids remaining for the vendor submitting that quote.

A computer device that hosts a marketplace is preferably configured such that a vendor that exhausts its allocated bids for a time period is prevented from submitting any more quotes within the time period. For instance, a vendor that only has one bid remaining may not submit a more costly premium bid that exceeds a cost of one bid.

Feedback Blocking

One or more computer devices that host an online marketplace may be configured to permit a vendor such as a seller to control a portion of customer feedback. The portion of the customer feedback a vendor can control may be correlated with the vendor quality rating for the vendor. Such feedback blocking functionality may provide another incentive to a vendor to provide quality services to customers.

For example, a computer device may be configured to determine a quality rating for a vendor and assign a block allowance rate or a set block allowance for a vendor. The blocking capacity for the vendor may be a portion of customer feedback that was transmitted to the computer device and is stored in memory of the computer device for displaying or transmitting to other customers. If a predetermined limit is set by a block allowance, a vendor may be permitted to block up to some portion of feedback such as, some number of graphic representations of buyer feedback, some number of message board entries concerning the vendor, or some quantitative size of data transmitted by customers.

If a block allowance rate is provided to the vendor, the vendor may block up to a certain percentage of feedback. For example, a block allowance rate of 10% may permit a vendor to block 10% of all customer feedback submitted to the computer device. The block rate may be based on the size of the customer feedback or by the number of messages submitted by customers.

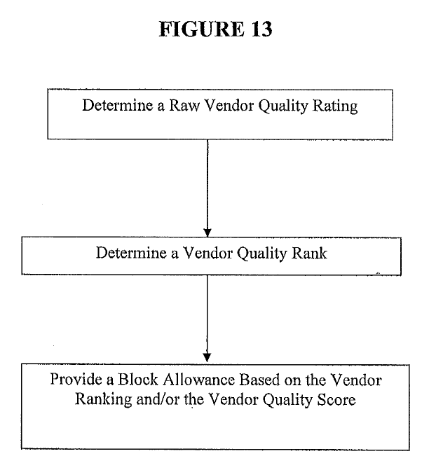

The blocking allowance rate may be determined by quality rating or other parameters, as may be appreciated by the present preferred method of determining a block allowance shown in FIG. 13. As may be appreciated from FIG. 13, a computer device can be configured to determine a raw vendor quality rating, such as a raw score, and determine a vendor ranking based on that score. A block allowance or block allowance rate may then be assigned to the vendor based on that vendor quality rating. For instance, a vendor with a better quality rating may be permitted a larger blocking rate than vendors having lesser quality ratings.

The block allowance rate for a vendor can be correlated with or aligned with a vendor quality rating. For example, a vendor with a particular vendor quality rating can be assigned a block allowance rate such that vendors with better quality ratings can block more feedback than vendors having lesser quality ratings. Table 8, which is shown below, provides one example of an assignment of blocking allowance rates based on vendor quality ratings.

TABLE 8
First Example of Blocking Allowance Rate

| Quality Score | |
|---|---|
| Percentile Rank For Vendor | Block Allowance Rate |
| Top 20% | 10% |
| Between 40% and 20% | 9% |
| Between 60% and 40% | 8% |
| Between 80% and 60% | 7% |
| Between 80% and 100% | 6% |

As may be appreciated from Table 8, a vendor having a top 20% quality rating may block 10% of customer feedback while a vendor having a lower rating may block less than 10% of customer feedback.

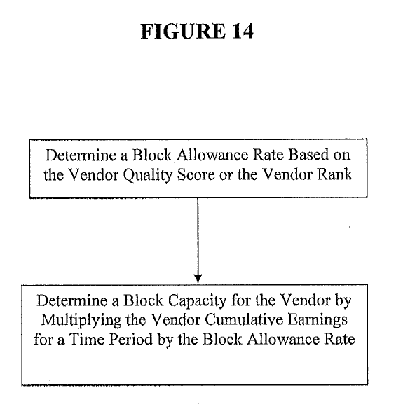

A vendor's blocking capacity may also be provided to a vendor based on the cumulative earnings of the vendor and based on the quality rating of the vendor, as may be appreciated from FIG. 14. Such functionality can help encourage vendors such as sellers to utilize the marketplace and also provide an incentive to provide quality service. Such a blocking capacity determination may be made by multiplying a block allowance rate by the cumulative earning of a vendor over a certain time period, which can also be illustrated as:

Blocking Capacity=(Cumulative earning over a certain time period)*(Block Allowance Rate).

It should be appreciated that the time period for which cumulative earnings are measured for a vendor may be the length of time the vendor has been a member of the marketplace or may be some lesser amount of time.

For example, a seller or other vendor that has cumulative earnings over the last twelve months of $100,000 and a quality score in the top 20% of the vendors of the marketplace may be permitted to block 10 percent of customer feedback. The blocking capacity of the seller may be $10,000 ($100,000*10%=blocking capacity). The one or more computer devices hosting the marketplace may be configured to permit the seller to “spend” this blocking capacity to block customer feedback on a project basis. For instance, a seller may be permitted to block customer feedback from a buyer of a project that paid the vendor $10,000 to complete the project. After that feedback is blocked, the seller will have exhausted its blocking capacity. As another example, the seller could instead choose to spend its block capacity by blocking one buyer's feedback from a $2,000 project and two buyers' feedback from $4,000 projects before its blocking capacity is exhausted.

A vendor's blocking capacity may be recalculated when the vendor's quality score and cumulative earnings are recalculated. This may occur daily or less or more often. After a recalculation, if a vendor receives an increase in blocking capacity, that increase may be added to the non-spent portion of the blocking capacity of the vendor for use in subsequent feedback blocking. Therefore, if a vendor initially had a blocking capacity of $10,000 and spent $7,000 of that capacity by blocking feedback from a $7,000 project, the vendor may have its blocking capacity increased if the recalculated blocking capacity was determined to be higher than the previous $10,000 capacity. For instance, if the blocking capacity increased $1,000 to $11,000, the vendor's remaining blocking capacity would be increased $1,000 to $4,000.

The one or more computer devices that host a marketplace may be configured to permit a vendor only a certain amount of time to block feedback before displaying that customer feedback. For instance, a vendor may be provided with customer feedback from a customer and given seven days to accept or block that feedback. If the vendor does not block the feedback, the computer device may be configured to accept the feedback by default as valid. Alternatively, the computer device may be configured to block any feedback that is not acted on until the vendor's blocking capacity is spent. If a vendor chooses to block feedback, the computer device can be configured to delete the feedback or may be configured to save the feedback for displaying to the vendor but not display that feedback to others. Such a display of feedback may be via displaying the feedback on webpages that may be accessed by a vendor or by sending a message to a vendor device such as a cell phone or vendor email account The entirety of the Freelancer Rating System Business Requirements Specification, Feedback System specification, and Pro Bidding: “Fast Track” Business Requirements Specification that are included in U.S. Provisional Patent Application Ser. No. 61/202,684 are incorporated herein by reference. It should be appreciated that these three business requirement specifications provide examples of how to make and use embodiments of the methods and apparatuses disclosed herein.

I have found that the embodiments of my invention disclosed herein help promote communication between disputing parties, removes opportunities for vendor or customer coercion, and facilitates the regular submission of valid feedback from customers and clients. Preferably, embodiments of my apparatuses configured to host or provide an online marketplace and methods of providing such apparatuses and services offered by the marketplace hosted by such apparatuses include bidding segmentation, objective vendor quality ratings and feedback blocking functionality. Of course, certain embodiments of the apparatuses or methods may be configured to only utilize some subset of such functionality. For instance, an apparatus for hosting an online marketplace may only be configured to objectively measure a vendor quality rating or only measure a vendor quality rating and bidding segmentation.

It should be understood that the above discussed marketplaces and devices configured to provide such marketplaces may provided to clients such as customers or vendors. The marketplaces may be provided by offering the marketplaces via a network such as the internet. The marketplaces may also be provided by contract with an internet service provider or other network provider to store or maintain certain data or programs that provides the marketplace services to others. Therefore, even though data or programs may be on a third party's server that is maintained by that third party, the entity or person providing the marketplace is the person that manages, updates or oversees the operation of the marketplace. Often, such an entity will have a service agreement with sellers, buyers, or other clients of the marketplace. A person or entity may also be considered to provide such a marketplace or devices configured to host such a marketplace by having an agreement with the vendors or clients to receive compensation from the vendor or customer or from both the vendor and the customer in return for their use of the services offered by the marketplace.

While certain present preferred embodiments of apparatuses configured to host or provide an online marketplace and methods of providing such apparatuses and services offered by the marketplace hosted by such apparatuses have been shown and described above, it is to be distinctly understood that the invention is not limited thereto but may be otherwise variously embodied and practiced within the scope of the following claims.

1-25. (canceled)

26. A method of providing a marketplace on at least one network comprised of a plurality of clients, the clients comprised of vendors and customers, the method comprising:
offering a marketplace hosted by at least one computer device configured to communicate with the clients via at least one network connection, the at least one computer device comprising at least one processor;
using the at least one processor to determine a vendor quality rating for each vendor;
determining the vendor quality rating by the at least one processor selecting a first time period and determining at least one of a customer retention value for the first selected time period, a customer earning value for the first selected time period and a customer acquisition value for the first selected time period.

27. The method of claim 26 wherein the vendor quality rating is determined by multiplying the customer retention value for the first selected time period, the customer earning value for the first selected time period and the customer acquisition value for the first selected time period.

28. The method of claim 26 wherein the vendor quality rating is determined by multiplying the customer retention value for the first selected time period and the customer earning value for the first selected time period.

29. The method of claim 26 wherein the vendor quality rating is determined by multiplying the customer earning value for the first selected time period and the customer acquisition value for the first selected time period.

30. The method of claim 26 wherein the at least one computer device is also configured to provide bidding segmentation and wherein bidding segmentation is provided by the at least one processor processing a bidding segmentation method.

31. The method of claim 26 wherein quote submission acceptability is determined by a method comprises selecting a second time period and determining a number of bids a vendor receives for the second selected time period, determining a bid cost for each quote submitted by the vendor, and determining a remaining number of bids for the vendor within the second selected time period, the vendor not being permitted to submit a quote when the cost of bids submitted by the vendor for a quote within the second selected time period is effectively greater than the remaining number of bids for the vendor within the second selected time period.

32. The method of claim 26 wherein the at least one computer device is also configured to provide feedback for the vendors, the at least one computer device configured to provide feedback such that the vendors are permitted to block a portion of feedback the customers transmit to the at least one computer device.

33. The method of claim 32 wherein the at least one processor is used to determine the portion of feedback a vendor is permitted to block by assigning a feedback block rate or a feedback block amount to the vendor, the feedback block rate or feedback block amount being correlated with the vendor quality rating such that a vendor with a first quality rating is permitted to block more feedback than a vendor having a quality rating that is lower than the first quality rating.

34. The method of claim 32 wherein the portion of feedback a vendor is permitted to block is determined by the at least one processor assigning a feedback block rate or a feedback block amount to the vendor, the feedback block rate or feedback block amount being correlated with the vendor quality rating such that a vendor with a first quality rating is permitted to block more feedback than a vendor having a quality rating that is higher than the first quality rating

35. The method of claim 32 wherein the portion of feedback a vendor is permitted to block is determined by the at least one computer device assigning a block allowance for a second selected time period to each vendor, the vendor being able to block feedback until the block allowance is exhausted within the second selected time period.

36. The method of claim 35 wherein the block allowance is determined by the at least one computer device multiplying cumulative earnings of the vendor within the second selected time period by a block allowance rate.

37. The method of claim 36 wherein the block allowance rate is determined such that a vendor with a first quality rating receives a greater block allowance rate than a vendor having a quality rating that is higher than the first quality rating.

38. The method of claim 36 wherein the block allowance rate is determined such that a vendor with a first quality rating receives a greater block allowance rate than a vendor having a quality rating that is lower than the first quality rating.

39. The method of claim 35 wherein the at least one computer device is also configured to provide quote submission acceptability, the quote submission acceptability determined by a the at least one processor processing a quote submission acceptability method comprising selecting a third time period, determining a number of bids a vendor receives for the third selected time period, determining a bid cost for each quote submitted by the vendor, and determining a remaining number of bids for the vendor within the third selected time period, the vendor not being permitted to submit a quote when the cost of bids submitted by the vendor for the quote within the third selected time period is effectively greater than the remaining number of bids for the vendor within the third selected time period.

40. The method of claim 26 wherein the customer retention value for the first selected time period for each vendor is calculated by the at least one processor determining a customer earning rate for a customer within the first selected time period for each customer of a vendor in the first selected time period, adding the customer earning rates within the first selected time period for each customer of the vendor together to identify a total customer earning rate for the vendor, dividing the customer earning rate for each customer of the vendor by the total customer earning rate to identify an average customer earning rate for each customer of the vendor for the first selected time period, multiplying the average earning rate for each customer of the vendor by a relationship time period to determine a customer retention rate for each customer of the vendor for the first selected time period, and adding the customer retention rate for each customer of the vendor together to determine a total customer retention rate for the first selected time period for the vendor, the relationship time period being a time period in which the vendor and that customer had a relationship, the relationship time period not being limited to being within the first selected time period.

41. The method of claim 26 wherein the customer earning value for the first selected time period for each vendor is calculated by determining an average customer earning rate for the vendor, the customer earning rate for each customer being determined by dividing earnings the vendor received from that customer by a portion of the first selected time period in which the vendor and that customer had a relationship.

42. The method of claim 26 wherein the customer acquisition value for the selected time period for each vendor is calculated by dividing a number of projects awarded to that vendor by new clients by a number of valid quotes submitted by that vendor, valid quotes and awarded projects not being counted for quotes submitted to a customer after a first project is awarded to the vendor by that customer.

43. The method of claim 26 wherein the at least one computer device is at least one server or at least one workstation and the at least one processor is at least one program configured for processing by the at least one computer device, a central microprocessor, at least one server microprocessor or at least one processor comprised of at least one semiconductor.

44. The method of claim 26 wherein the at least one computer device is configured to communicate with the clients via internetworking.

45. A method of providing a marketplace on at least one network comprised of a plurality of clients, the clients comprised of vendors and customers, the method comprising:
offering a marketplace hosted by at least one computer device configured to communicate with the clients via at least one network connection, the at least one computer device comprising at least one processor;
using the at least one processor to determine a vendor quality rating for each vendor;
determining the vendor quality rating by the at least one processor selecting at least one of a first time period, a second time period and a third time period and determining at least one of a customer retention value for the first selected time period, a customer earning value for the second selected time period and a customer acquisition value for the third selected time period, the first selected time period being a different time period than at least one of the second selected time period and the third selected time period.
